(19) United States
(12) Patent Application Publication
(10) Pub. No.: US 2005/0057699 A1
(43) Pub. Date: Mar. 17, 2005

(54) Remote master control

(76) Inventor: Todd S. Bowser, Yardley, PA (US)

Correspondence Address: RATNERPRESTIA, P O BOX 980, VALLEY FORGE, PA, 19482-0980, US

(21) Appl. No.: 10/663,133

(22) Filed: Sep. 16, 2003

(51) Int. Cl. H04N 5/44

(52) U.S. Cl. 348/734

(57) ABSTRACT

An apparatus, method, and system for controlling electronic devices with a remote master control device is disclosed. The apparatus, method, and system are especially useful for monitoring and controlling electronic devices such as televisions to manage viewing habits and to supervise programming content presented by the electronic devices.

### FIELD OF THE INVENTION

The present invention relates to the field of electronics and, more particularly, to apparatus, methods, and systems for monitoring and controlling electronic devices with a remote control device.

### BACKGROUND OF THE INVENTION

A staggering amount of audio/video programming is currently available for presentation through electronic devices, e.g., televisions. Many audio/video programming viewers, especially young viewers, have excessive viewing habits and frequently become so captivated by a program that they fail to respond to outside stimuli, e.g., a parent's call to the dinner table. In addition, many of the available programs contain material that is unsuitable for younger viewers. Accordingly, apparatus, methods, and systems for monitoring and controlling electronic devices are useful to manage viewing habits and to protect younger viewers from unsuitable material.

Presently, systems are available for controlling electronic devices to censor programming available through these devices. Typically, these systems employ an on-screen display to configure the system. Using the on-screen display, a user configures the system to selectively block programming, e.g., programs having a certain maturity rating. In these systems, the user must access the on-screen display for each change to the existing configuration. Accessing the on-screen display for every configuration change is often cumbersome and inconvenient. Thus, users may be discouraged from using these systems. In addition, these systems do not permit monitoring of the programming available through these electronic devices.

Accordingly, there is a need for methods, systems, and apparatus to monitor and control electronic devices that are convenient to use. The present invention satisfies this need among others.

### SUMMARY OF THE INVENTION

The present invention is a method, system, and apparatus for controlling the use of an electronic device. The aforementioned need is satisfied through the use of a remote master control device for controlling the electronic device. In accordance with certain exemplary embodiments, when the electronic device receives a master instruction from the remote master control device, the electronic device is non-responsive to conflicting instructions from a secondary control device. In addition, in certain other exemplary embodiments, rating selection modes are sequential selected responsive to a rating selection signal generated by the remote master control device.

An exemplary apparatus in accordance with one aspect of the present invention includes a remote master control device configured to generate at least one master instruction, a secondary control device configured to generate at least one secondary instruction, and a signal processing device responsive to the at least one master instruction and selectively responsive to the at least one secondary instruction, wherein when the signal processing device receives one of the at least one master instruction, the signal processing device is non-responsive to a conflicting one of the at least one secondary instruction until the signal processing device receives an override instruction corresponding to the received master instruction.

An alternative exemplary apparatus in accordance with another aspect of the present invention includes a remote control device configured to generate a rating selection signal, and a signal processing device responsive to the rating selection signal, wherein the signal processing device is configurable in at least two rating selection modes and wherein the signal processing device is sequentially configured in one of the at least two rating selection modes responsive to the receipt of the rating selection signal from the remote control device.

An alternative exemplary apparatus in accordance with another aspect of the present invention includes a remote control device configured to generate a channel lock signal and a signal processing device responsive to the channel lock signal. The signal processing device is configured to lock out a currently tuned channel responsive to the channel lock signal from the remote control device.

An alternative exemplary apparatus in accordance with another aspect of the present invention is a remote control including a transmitter and a controller coupled to the transmitter. The transmitter is capable of communicating with the signal processing device. The controller is capable of generating and transmitting from the transmitter at least one control instruction capable of configuring the signal processing device. The remote control device can be locked and unlocked, wherein the signal processing device is not configured by at least one of the at least one control instruction when the remote control device is locked.

An alternative exemplary apparatus in accordance with another aspect of the present invention includes a remote control device and a signal processing device. The remote control device is configured to generate at least one message instruction corresponding to a message. The signal processing device is configured to present the message at a presentation device responsive to the at least one message instruction.

An alternative exemplary apparatus in accordance with another aspect of the present invention includes a remote control device and a signal processing device. The remote control device is configured to generate at least one monitoring instruction and includes at least one presentation component. The signal processing device is configured for bi-directional communication with the remote control device. The signal processing device receives an input signal and passes at least a portion of the input signal to the remote control device responsive to the at least one monitoring instruction for presentation by the presentation component.

An exemplary method in accordance with one aspect of the present invention includes receiving at least one master instruction from a remote master control device, receiving at least one secondary instruction from a secondary control device, configuring a signal processing device responsive to the at least one master instruction, and selectively configuring the signal processing device responsive to the at least one secondary signal, wherein, when one of the at least one master instruction is received, the signal processing device is not configured in response to the receipt of a conflicting one of the at least one secondary instruction until an override instruction corresponding to the received master instruction is received. This method may be implemented in software as a computer readable medium that is configured to control a general purpose computer.

An alternative exemplary method in accordance with another aspect of the present invention includes receiving a rating selection signal from a remote control device and configuring a signal processing device responsive to the rating selection signal, wherein the signal processing device is sequentially configured in one of at least two rating selection modes responsive to the receipt of the rating selection signal from the remote control device. This method may be implemented in software as a computer readable medium that is configured to control a general purpose computer.

An alternative exemplary method in accordance with another aspect of the present invention includes receiving a channel lock signal from a remote control device and configuring a signal processing device responsive to the channel lock signal, wherein the signal processing device is configured to lock out a currently tuned channel for a predefined period of time or the remainder of a program on the currently tuned channel responsive to the receipt of the channel lock signal from the remote control device. This method may be implemented in software as a computer readable medium that is configured to control a general purpose computer.

An alternative exemplary method in accordance with another aspect of the present invention includes receiving a lock keystroke sequence at a remote control device configured for use with a signal processing device and locking the remote control device responsive to the lock keystroke sequence such that the signal processing device is not configured responsive to at least one control instruction. This method may be implemented in software as a computer readable medium that is configured to control a general purpose computer.

An alternative exemplary method in accordance with another aspect of the present invention includes generating a message instruction at a remote control device, receiving the message instruction at a signal processing device, and presenting a message at a presentation device responsive to the message instruction generated by the remote control device. This method may be implemented in software as a computer readable medium that is configured to control a general purpose computer.

An alternative exemplary method in accordance with another aspect of the present invention includes receiving a monitoring instruction from a remote control device having at least one presentation component at a signal processing device, the signal processing device configured to present an input signal at a presentation device, passing at least a portion of the input signal to the remote control device responsive the received monitoring instruction, and presenting the portion of the input signal at the at least one presentation component of the remote control device. This method may be implemented in software as a computer readable medium that is configured to control a general purpose computer.

An exemplary system in accordance with one aspect of the present invention includes means for receiving at least one master instruction from a remote master control device, means for receiving at least one secondary instruction from a secondary control device, means for configuring a signal processing device responsive to the at least one master instruction, and means for selectively configuring the signal processing device responsive to the at least one secondary signal, wherein, when one of the at least one master instruction is received, the signal processing device is not configured in response to the receipt of a conflicting one of the at least one secondary instruction an override instruction corresponding to the received master instruction is received.

### BRIEF DESCRIPTION OF THE DRAWINGS

FIG. 1 depicts an audio/video (A/V) system in accordance with an exemplary embodiment of the invention;

FIG. 2A depicts an exemplary remote master control device for use in the A/V system of FIG. 1;

FIG. 2B depicts an exemplary secondary control device for use in the A/V system of FIG. 1;

FIG. 3 depicts a flow chart of an exemplary method for configuring a signal processing device in accordance with one aspect of the present invention; and

FIG. 4 depicts a flow chart of an exemplary method for configuring a signal processing device in accordance with another aspect of the present invention.

### DETAILED DESCRIPTION OF THE INVENTION

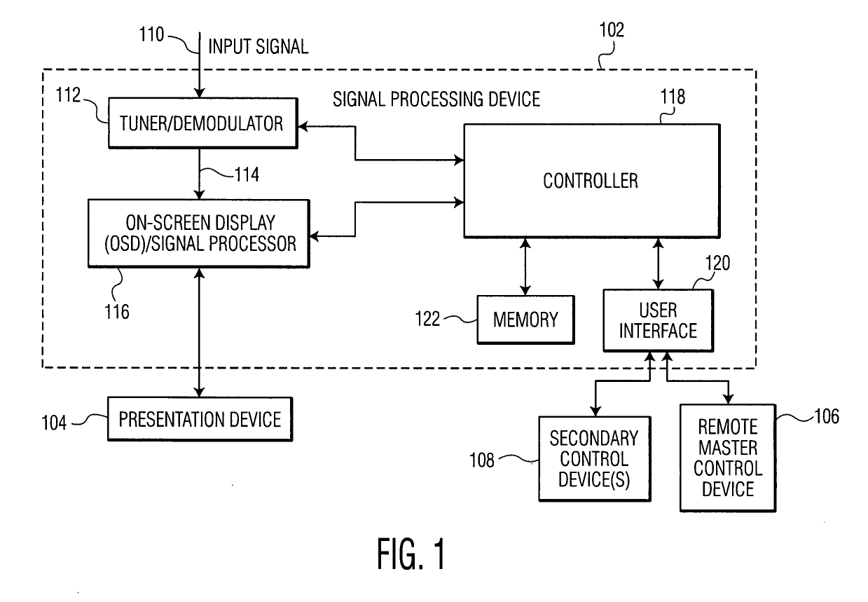

FIG. 1 depicts an exemplary embodiment of an audio/video (A/V) system 100 in accordance with the present invention. The illustrated A/V system 100 includes a signal processing device 102, a presentation device 104 (e.g., a television monitor), a remote master control device 106, and one or more secondary control devices 108. The signal processing device 102 is configurable for use with the presentation device 104. In exemplary embodiments, the signal processing device 102 is implemented in an integrated receiver/decoder (IRD) contained within a television receiver or a set-top box (not shown), which may contain additional circuitry, configured for use with a television receiver or a television monitor.

In the illustrated signal processing device 102, an input signal 110 (e.g., an NTSC television signal) is applied to a tuner/demodulator 112. The tuner/demodulator 112 tunes and demodulates the input signal 110 to yield a demodulated input signal 114. The demodulated input signal 114 is provided to an on-screen display (OSD)/signal processor 116, which processes the demodulated input signal 114 for presentation by the presentation device 104. The OSD/television signal processor 116 may be a conventional analog or digital television signal processing system, including circuits for decoding and processing both audio and video components of the demodulated input signal 114, coupled to a conventional OSD processor. The presentation device 104 presents the processed signals received from the OSD/signal processor 116.

A controller 118 controls the tuner/demodulator 112 and the OSD/signal processor 116. In addition, in accordance with exemplary embodiments of the present invention, the controller 118 configures components within the signal processing device 102 responsive to user instructions received through a user interface 120 to provide one or more of a variety of monitoring and control functions, which are described in detail below. The controller 118 is coupled to a conventional memory 122. A suitable controller 118 for use in the present invention will be readily apparent to those of skill in the art of television signal processing.

The user interface 120 provides an interface between the controller 118 and the remote master and secondary control devices 106, 108. The user interface 120 communicates with the control devices 106, 108 using wired and/or wireless communication systems such as infrared (IR) or radio frequency (RF) communication systems. In an exemplary embodiment, the user interface 120 provides unilateral communication from one or more control devices 106, 108 to the controller 118. In certain exemplary embodiments, the user interface 120 provides bilateral communication between the controller 118 and at least one of the control devices 106, 108. In certain exemplary embodiments, the user interface 120 includes multiple user interfaces. For example, the user interface 120 may include a RF transceiver for communication with the remote master control device 106 and an IR receiver for receiving communications from the secondary remote control device 108. Suitable user interfaces will be readily apparent to those of skill in the art of signal processing.

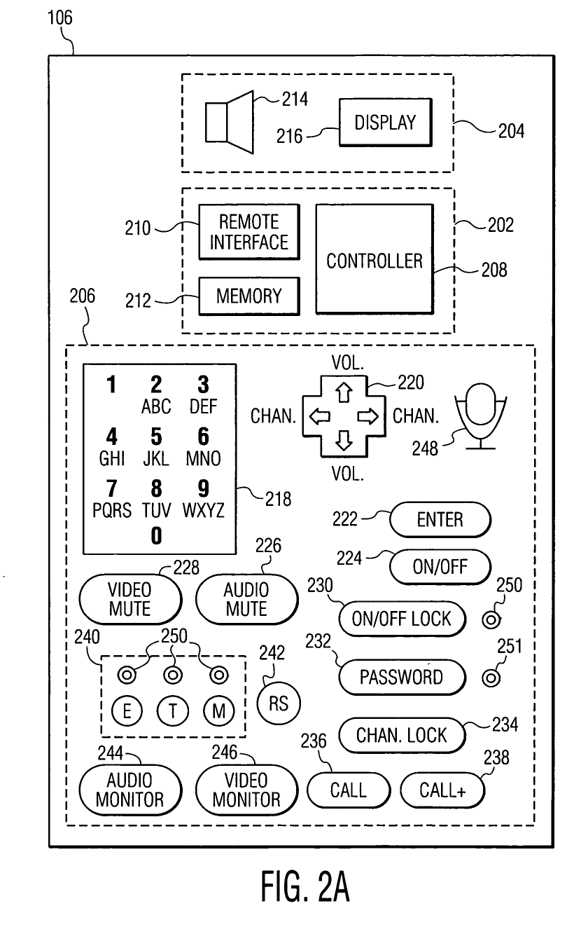

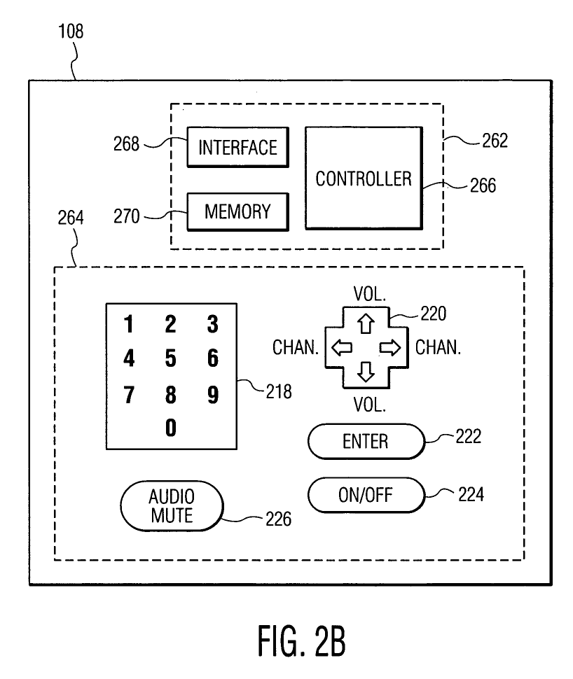

FIG. 2A depicts an exemplary remote master control device 106 for use in accordance with the present invention. The illustrated remote master control device 106 includes control components 202, presentation components 204, and user inputs 206. The illustrated control components 202 include a controller 208, a remote interface 210, and a memory 212. In an exemplary embodiment, the controller 208 controls the individual components within the remote master control device 106, and generates and processes signals for communication between the individual components of the remote master control device 106 and with the signal processing device 102 (FIG. 1) through the remote interface 210. In addition, the controller 208 generates instructions responsive to user inputs 206 for performing one or more of the variety of monitoring and control functions described below. In an exemplary embodiment, the memory 212 is a conventional memory capable of storing data for use by the controller 208. The controller 208 is connected to the remote interface 210, memory 212, presentation components 204, and user inputs 206 via unidirectional and/or bi-directional communication paths. For the sake of simplicity, these paths are not shown in FIG. 2A. In certain exemplary embodiments, a memory is unnecessary and can be excluded. A suitable controller 118 for use in the present invention will be readily apparent to those of skill in the art of television signal processing.

The remote interface 210 enables communication with the user interface 120 (FIG. 1) of the signal processing device 102 (FIG. 1). In exemplary embodiments, the remote interface 202 communicates with the user interface 120 using a wired connection or a wireless connection, e.g., using IR or RF signals. In an exemplary embodiment, the remote interface 202 communicates with the user interface 120 unilaterally, sending instructions to the signal processing device. In an alternative exemplary embodiment, the remote interface 202 is capable of bilateral communication with the user interface of the signal processing device, sending instructions to and receiving data from the signal processing device. In certain exemplary embodiments, RF signaling is used, allowing the remote master control device 106 to communicate with the signal processing device without a direct line of sight between the devices.

The illustrated presentation devices 204 include a speaker 214 and a display 216. In an exemplary embodiment, the speaker 214 and the display 216 are capable of presenting audio and video signals, respectively. In certain exemplary embodiments, the display 216 is a touch screen capable of receiving user inputs. In accordance with this embodiment, the display 216 may be configured to present “virtual buttons” associated with certain instructions that a user selects in a conventional manner. Suitable speakers and displays for use with the present invention will be readily apparent to those of skill in the art of television electronics. In certain exemplary embodiments, audio and/or video signals are not presented at the remote master control device 106, thereby eliminating the need for the speaker 214 and/or display 216, respectively.

The illustrated user inputs 206 include a conventional keypad 218, arrow keys 220, an enter button 222, an on/off button 224, an audio mute button 226, a video mute button 228, an on/off lock button 230, a password button 232, a channel lock button 234, a call button 236, a call plus button 238, rating selection buttons 240, a one-touch rating selection button 242, an audio monitor button 244, a video monitor button 246, and a microphone 248. The illustrated user inputs 206 are merely exemplary and many more or less user input buttons, keys, and components may be provided. In an exemplary embodiment, pressing certain of the individual keys and buttons causes the controller 208 to generate instructions associated with corresponding monitoring and control functions, which are described in detail below. In certain exemplary embodiments, one or more of the keys and buttons has an associated indicator 250, 251 used to indicate the state of a certain monitoring or control function. It will be recognized by those of skill in the art that if the display 216 is a touch pad display, one or more of the user inputs 206 can be implemented through the touch pad display thereby eliminating the need for one or more of the illustrated keys and buttons.

FIG. 2B depicts an exemplary secondary control device 108 for use in accordance with the present invention. The illustrated secondary control device 108 includes control components 262 and user inputs 264. The illustrated control components 262 include a controller 266, an interface 268, and a memory 270. In an exemplary embodiment, the controller 266 controls the individual components within the secondary control device 108, and generates and processes signals for communication between the individual components of the secondary control device 108 and with the signal processing device 102 (FIG. 1) through the interface 268. In addition, the controller 266 generates instructions responsive to the user inputs 264 for controlling the signal processing device 102. The controller 266 is connected to the interface 268, memory 270, and user inputs 264 via unidirectional and/or bi-directional communication paths. For the sake of simplicity, these paths are not shown in FIG. 2B. In an exemplary embodiment, the memory 270 is a conventional memory capable of storing data for use by the controller 266. In certain exemplary embodiments, a memory is unnecessary and can be excluded. A suitable controller 266 for use in the present invention will be readily apparent to those of skill in the art of television signal processing.

The interface 268 enables communication with the user interface 120 (FIG. 1) of the signal processing device 102 (FIG. 1). In exemplary embodiments, the interface 268 communicates with the user interface 120 using a wired connection or a wireless connection, e.g., using IR or RF signals. In an exemplary embodiment, the interface 268 communicates with the user interface 120 unilaterally, sending instructions to the signal processing device. In exemplary embodiments, the secondary control device 108 may be a remote control device or a control device attached to the signal processing device 102 (FIG. 1), e.g., a control pad.

In an exemplary embodiment, the user inputs 264 are a subset of the user inputs 206 (FIG. 2A) of the remote master control device 106 (FIG. 2A). The illustrated user inputs 264 include a conventional keypad 218, arrow keys 220, an enter button 222, an on/off button 224, and an audio mute button 226. The illustrated user inputs 264 are merely exemplary and many more or less buttons and keys may be provided, including keys not present on the remote master control device 106 (FIG. 2A). In an exemplary embodiment, pressing certain of the individual keys or buttons causes the controller 266 to generate instructions associated with that key or button for performing corresponding control functions, which are described in detail below.

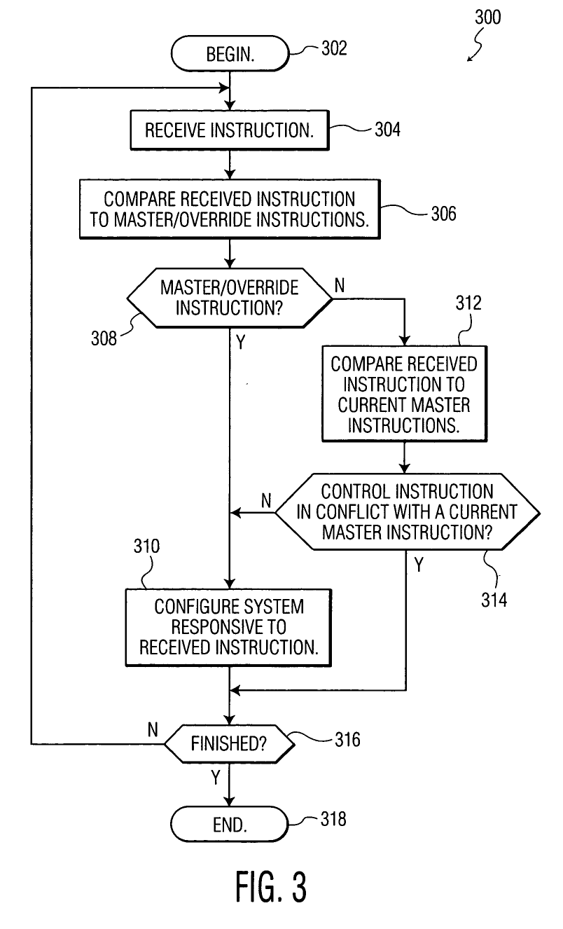

FIG. 3 depicts a flow chart 300 of exemplary steps for configuring a signal processing device 102 (FIG. 1) based on instructions received from a remote master control device 106 (FIGS. 1 and 2A) and a secondary control device 108 (FIGS. 1 and 2B) in accordance with one aspect of the present invention. Processing begins at block 302 with the receipt of an instruction at block 304. In an exemplary embodiment, a signal processing device receives the instruction from a control device such as the remote master control device or the secondary control device. In certain exemplary embodiments, the signal processing device generates an instruction internally, e.g., in response to a previously set countdown timer reaching zero.

In an exemplary embodiment, the instruction is a master instruction, an override instruction, or a secondary instruction. In an exemplary embodiment, the remote master control device generates the master instructions and the override instructions and the secondary control device generates other instructions (e.g., secondary instructions). In certain exemplary embodiments, override instructions are generated by the remote master control device and internally by the signal processing device. For example, the override instruction may be generated by pressing a key on the remote control device or internally by the signal processing device, e.g., by a timer. The override instruction may include one or more instructions that conflict with a master instruction. For example, if the master instruction is an OFF instruction for removing power from a presentation device, the override instruction may be an ON instruction to restore power. In certain exemplary embodiments, the master instruction and the override instruction may be essentially the same or identical instructions. For example, the master instruction may be an ON/OFF instruction, which the signal processing device uses to remove power from the presentation device if the signal processing device is currently supplying power to the presentation device and to restore power to the presentation device if the signal processing device is currently not supplying power to the presentation device. In this embodiment, the override instruction may also be the ON/OFF instruction, which restores power when the master instruction removes power and removes power when the master instruction restores power.

Secondary instructions are instructions other than the master instructions and the override instructions. In an exemplary embodiment, the secondary control device generates the secondary instructions.

In an exemplary embodiment, the remote master instructions and override instructions are unique instructions associated with the remote master control device. In certain exemplary embodiments, the master instructions and/or the override instructions include an identification key that identifies the instructions as originating from the remote master control device. In accordance with this embodiment, the instruction may be broken into two parts. Specifically, a first part identifies a source of the instructions and the second part identifies an action to be performed such as configuring the signal processing device. For example, for an off instruction, the remote master control may generate a master instruction with a unique source identifier and a common action identifier (e.g., toggle power) and the secondary control device may generate a secondary instruction with a unique source identifier and the common action identifier. In an alternative embodiment, the remote master control device may generate instructions having no commonality with instructions generated by other control devices such as the secondary control device.

At block 306, the received instruction is compared to master instructions and override instructions. In certain exemplary embodiments, the master instructions and override instructions are stored in a memory for comparison to the received instruction.

At block 308, a decision is made regarding the comparison of the received instructions to the master/override instructions. If the received instruction matches a master instruction or an override instruction, processing proceeds at block 310. Otherwise, processing proceeds at block 312.

At block 310, the system is configured responsive to the received instruction. In an exemplary embodiment, the controller configures the signal processing device in accordance with the received instruction.

At block 312, the received instruction is compared to current master instructions. In an exemplary embodiment, the instructions are compared to determine is a conflict exists between the current master instructions and the received instructions. A conflict occurs if the received instruction is an instruction to configure an aspect of the system contrary to the manner in which a current master instruction instructed configuration of the system. For example, if a master instruction instructs the signal processing device to remove power from (e.g., turn off) the presentation device, an instruction to restore power to (e.g., turn on) the presentation device is a conflicting instruction. In another example, if a master instruction instructs the signal processing device to inhibit tuning of a particular channel, an instruction to tune to that channel is the conflicting instruction. In certain exemplary embodiments, a conflicting operation is not a conflicting instruction. For example, in one exemplary embodiment, if a master instruction instructs the signal processing device to restore power, a secondary instruction to remove power is not a conflicting instruction. Thus, in accordance with this embodiment, the remote master control device and the secondary control device are always able to remove power from (e.g., turn off) the presentation device. Various alternative conflicting instructions will be readily apparent to those skilled in the art.

In an exemplary embodiment, current master instructions are instructions from the remote master control device that have been received and used by the controller to configure the signal processing device in its present state. The master instruction is considered a current master instruction until a corresponding override signal is received. After a corresponding override instructions is received, the master instruction is no longer a current master instruction. In an exemplary embodiment, the current master instructions are stored in the memory 122 (FIG. 1) to facilitate comparison with the received instruction. In accordance with this embodiment, when an override instruction is received, the controller 118 (FIG. 1) removes the corresponding master instruction from the memory 122.

At block 314, a decision is made regarding the comparison of the received instructions to the current master instructions. If the received instruction is in conflict with a current master instruction, processing proceeds at block 316 without configuring the system responsive to the received instruction. Otherwise, processing proceeds at block 310 with the system being configured responsive to the received instruction.

At block 316, a decision is made to determine if the processing of received instructions is finished. If the processing of received instructions is finished, processing ends at block 318. Otherwise processing proceeds at block 304 with the receipt of another instructions. In an exemplary embodiment, the processing of signals continues until power is removed from the signal processing device.

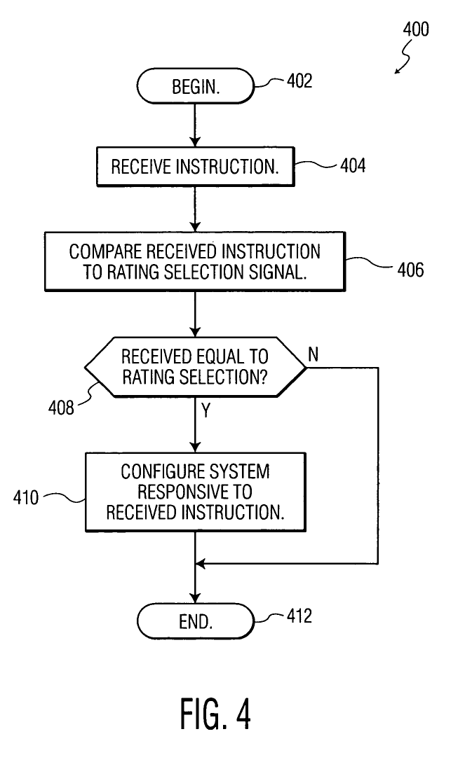

FIG. 4 depicts a flow chart 400 of exemplary steps for configuring a signal processing device 102 (FIG. 1) based on instructions received from a remote master control device 106 (FIG. 1) in accordance with another aspect of the present invention. Processing begins at block 402 with the receipt of an instruction at block 404. In an exemplary embodiment, a signal processing device receives the instruction from the remote master control device.

At block 406, the received instruction is compared to a rating selection instruction. In an exemplary embodiment, the rating selection signal is unique to the remote master control device and can not be generated by the secondary control devices.

At block 408, a decision is made regarding the comparison of the received instruction to the rating selection instruction. If the received instruction matches the rating selection signal, processing proceeds at block 410. Otherwise, processing ends at block 412.

At block 410, the system is configured responsive to the received instruction. In an exemplary embodiment, the signal processing device is configured by the controller in accordance with the received instruction. Processing then ends at block 412.

Referring back to FIGS. 1, 2A, and 2B, various monitoring and control functions of the signal processing device 102 and control device 106, 108 are now described. The following functions are non-limiting examples of functions that may be implemented in the A/V system 100 of the present invention. In certain exemplary embodiments, one or more of the following functions are incorporated into the A/V system 100 of the present invention. An exemplary method is provided for implementing each function, however, other methods of implementing the described functions will be readily apparent to those of skill in the art and are considered within the scope of the present invention. In addition, other functions that will be readily apparent to those of skill in the art from the below described functions are considered within the scope of the present invention.

In accordance with one exemplary embodiment of the present invention, the remote master control device 106 can be locked. In certain exemplary embodiments, when the remote master control device 106 is locked, the remote master control device 106 is unable to transmit instructions or the controller 118 of the signal processing device 102 will not acknowledge the instructions, thus preventing the use of the remote master control device by an unauthorized user, e.g., a child. In certain other exemplary embodiments, only a portion of the remote master control device 106 is locked. For example, the instructions associated with certain control and monitoring keys and buttons may be locked while others remain inactive. In accordance with this embodiment, when locked, the remote master control device may behave as a secondary control device.

In an exemplary embodiment, pressing the password activation button 232 (FIG. 2A) initiates a password activation sequence. In accordance with this embodiment, the remote master control device 106 is locked and unlocked responsive to a password, e.g., a sequence of one or more keystrokes, entered using the user inputs 206. For example, a user can lock the remote master control device 106 by entering a lock keystroke sequence, e.g., by pressing the password activation button 232 and entering a password using a combination of user inputs 206, for example. The user can then unlock the remote master control device by entering an unlock user sequence, e.g., by pressing the password activation button 232 and reentering the password. Thus, in this embodiment, the lock and unlock keystroke sequences are identical. In an alternative embodiment, a user locks the remote master control with a single press of the password activation button (i.e., the lock sequence) and unlocks the remote master control device by pressing the password activation button and reentering the password (i.e., the unlock keystroke sequence). In certain exemplary embodiments, a visual identification is provided to the user that indicates whether the remote is locked, e.g., an indicator 251 (FIG. 2a) is illuminated when the remote master control device 206 is locked.

In accordance with another exemplary embodiment, the audio component of a demodulated input signal can be monitored with the remote master control device, thus enabling monitoring of the audio component presented by the presentation device 104. In certain exemplary embodiments, pressing the audio monitor button 244 on the remote master control device activates this audio monitor feature. Pressing the audio monitor button 244 causes the remote master control device to transmit an instruction to the signal processing device requesting the audio component of the demodulated input signal 114 being processed by the signal processing device. The signal processing device then passes the audio component to the remote master control device for aural presentation, e.g., via the speaker 214. In certain exemplary embodiments, a second press of the audio monitor button 244 terminates monitoring of the audio component.

In accordance with another exemplary embodiment, the video component of the demodulated signal 110 can be monitored with the remote master control device 106, thus enabling monitoring of the video signal displayed on the presentation device 104. In certain exemplary embodiments, pressing the video monitor button 246 activates this video monitor feature. Pressing the video monitor button 246 on the remote master control device causes the remote master control device to transmit an instruction to the signal processing device requesting the video component of the demodulate input signal 114 (FIG. 1). The signal processing device then passes the video component to the remote master control device for visual presentation, e.g., via the display 216. In certain exemplary embodiments, a second press of the video monitor button 246 terminates monitoring of the video component. In certain exemplary embodiments, the video component is down sampled, e.g., by the OSD/signal processor 116, prior to passing to the remote master control device to reduce the bandwidth needed for the transmission.

In accordance with another exemplary embodiment, the audio component of the demodulated input signal can be muted (i.e., inhibited). In certain exemplary embodiments, pressing the audio mute button 226 of the remote master control device activates this audio mute feature. Pressing the audio mute button 226 causes the remote master control device to transmit an instruction to the signal processing device instructing the signal processing device to inhibit the presentation of the audio component of the demodulate input signal at the presentation device 104. In certain exemplary embodiments, a second press of audio mute button 226 or the press of another key on the remote master control device such as arrow keys 220 indicative of a volume change resumes presentation of the audio component.

In certain exemplary embodiment, the secondary control device 108 can also invoke the audio mute function. For example, pressing the audio mute button 226 on the secondary control device 108 causes the secondary control device to transmit an instruction to the signal processing device instructing the signal processing device to inhibit the presentation of the audio component of the demodulate input signal at the presentation device 104. In certain exemplary embodiments, a second press of the audio mute button 226 or the press of another key such as arrow keys 220 indicative of a volume change on either the secondary control device or the remote master control device resumes presentation of the audio component. In certain exemplary embodiments, when the audio mute function is invoked using the remote master control device, a conflicting instruction from the secondary control device, e.g., a press of the audio mute button 226 or the press of another key indicative of a volume change, is unable to resume presentation of the audio component on the presentation device.

In accordance with another exemplary embodiment, the video component of the demodulated input signal can be muted (i.e., inhibited). In certain exemplary embodiments, the video mute button 228 of the remote master control device activates this video mute feature. Pressing the video mute button 228 causes the remote master control device to transmit an instruction to the signal processing device instructing the signal processing device to inhibit the presentation of the video component of the demodulate input signal at the presentation device 104. In certain exemplary embodiments, the presentation of the video component at the presentation device 104 resumes upon a second press of the video mute button 228 or the press of another key such as arrow keys 220 indicative of a channel change. In an exemplary embodiment, when the video mute function is invoked using the remote master control device, a conflicting instruction from the secondary control device, e.g., the press of a key indicative of a channel change, is unable to resume visual presentation of the video component on the presentation device.

In accordance with another exemplary embodiment, the presentation device 104 can be shut down, e.g., power can be removed, powered on, e.g., power can be restored. In certain exemplary embodiments, the on/off lock button 230 activates this feature. Pressing the on/off lock button 230 causes the remote master control device to transmit an instruction to the signal processing device instructing the signal processing device to remove/restore power from/to the presentation device 104. Pressing the on/off lock button 230 a second time or pressing another key such as the on/off button 224 on the remote master control device restores/removes power to/from the presentation device. In accordance with an exemplary embodiment, when the on/off lock button 230 of the remote master control device is used to remove/restore power from the presentation device, a conflicting instruction from the secondary control device such an instruction generated in response to pressing the on/off button 224 of the secondary control device is unable to restore/remove power. In certain exemplary embodiments the on/off lock button 230 is an off button that generates an instruction only for removing power from the presentation device 104. Thus, if power was already removed from the presentation device and the user intended to remove power from the presentation device, the user could not accidentally restore power with the off button in accordance with this embodiment.

In accordance with another exemplary embodiment, channels can be locked out. In certain exemplary embodiments, the channel lock button 234 activates this channel lock feature. Pressing the channel lock button 234 causes the remote master control device to generate and transmit an instruction to the signal processing device to add the currently tuned channel to a locked-out channel list, for example. Thereafter, the signal processing device may be prohibited from tuning to channels in the locked-out list. In certain exemplary embodiments, pressing the channel lock button 234 locks out the currently tuned channel for a predefined period of time, e.g. 30 minutes. To lock the channel out for longer periods of time, the channel lock button 234 can be pressed multiple times. For example, pressing the lockout button once may lock out the currently tuned channel for 30 minutes, pressing the channel lock button 234 twice locks out the currently tuned channel for two 30 minute time periods, e.g., one hour, etc. In certain other exemplary embodiments, the user may specify a time period from an on-screen display generated by the OSD/signal processor 116 using the arrow keys 220 and/or keypad 218 after pressing the channel lock button 234. In certain other exemplary embodiments, pressing the channel lock button 234 (e.g., once or twice in quick succession) locks out the currently tuned channel for the duration of the program being shown on the currently tuned channel. In accordance with this embodiment, the controller 118 (FIG. 1) in the signal processing device 102 (FIG. 1) can calculate a remaining time period corresponding to the program from a program guide signal supplied to the signal processing device 102 and decoded by the tuner/demodulator 112 (FIG. 1). Various other techniques for locking out the currently tuned channel will be readily apparent from these exemplary embodiments and are considered within the scope of the present invention.

Once a channel is locked out using the remote master control device, the signal processing device does not respond to conflicting instructions from a secondary control device, e.g., an instruction to tune to the locked out channel using the key pad 218 or arrow keys 220 to identify that channel. In certain exemplary embodiments, when an arrow key is used in an attempt to move to a locked channel, the signal processing device tunes to the next non-locked channel. For example, if the user is on channel 33 and channel 34 is locked, pressing the up arrow will result in the signal processing device tuning to channel 35.

The locked channel is unlocked automatically at the end of the determined period. For example, the controller 118 may monitor a system clock (not shown) and at the end of the time period may unlock the channel. Thus, the system clock within the signal processing device produces an override instruction. In certain exemplary embodiments, the locked channel is unlocked by tuning to that channel using the keypad 218 or arrow keys 220 of the remote master control device. Thus, the remote master control device produces the override instruction.

In accordance with another exemplary embodiment, the presentation of the audio and/or video signals by the presentation device may be interrupted with a message. In certain exemplary embodiments, the call button 236 activates this interruption feature. When the call button 236 is pressed, the remote master control device generates and transmits an instruction to the signal processing device to present a message at the presentation device. The message may be an audio and/or video message stored in a memory. For example, the message may be a prerecorded audio message for presentation by the presentation device stating “dinner is ready” in lieu of the audio component of the demodulated input signal. In another example, the message may be a pre-selected video message for presentation by the presentation device that replaces the video component with text on a black screen stating “dinner is ready.” In another example, a user may input a textual message for presentation using the key pad 218, which the user may view and edit via the display 216. In another example, the message may be both an audio message and a video message.

In accordance with another exemplary embodiment, the presentation of the audio and/or video signals by the presentation device may be interrupted with a live message from the remote master control device. In certain exemplary embodiments, the call plus (+) button 238 activates this live message feature. For example, pressing the call+ button may cause the remote master control device to activate the microphone 248. The microphone 248 captures a live audio message from a user and the controller 208 generates and transmits the live message and an instruction to the signal processing device to present the message at the presentation device 104. In another example, pressing the call+ button may cause the remote master control device to capture a live text message from a user (e.g., entered via the keypad 218 and edited with feedback from the display 204) and the controller 208 generates and transmits the live message and an instruction to the signal processing device to present the message at the presentation device 104. In accordance with these embodiments, the audio and/or video components of the demodulated input signal may be partially or fully inhibited during the presentation of the message.

In accordance with another exemplary embodiment, rating level selections can be made using the remote master control device. In one embodiment, rating level modes are established for a plurality of users, e.g., 3 users. For example, an everyone (E) rating level mode, a teen (T) rating level mode, and a mature (M) rating level mode can be established using a conventional on-screen display menu presented on the presentation device. Thereafter, a user of the remote master control device can select an appropriate rating level mode by pressing a corresponding rating selection key 240. In certain exemplary embodiments, indicators 250 are selectively illuminated to indicate the current rating selection mode.

In an alternative exemplary embodiment, a rating selection button 242 may be used to select the appropriate rating level mode. In accordance with this embodiment, pressing the rating selection button 242 changes the rating level mode, e.g., sequentially cycling through the rating level modes. Thus, pressing a single key (e.g., the rating selection key 242) allows the selection of a desired rating level mode from the two or more rating level modes. If only two rating level modes are available, pressing the rating selection key 242 toggles between the two rating level modes.

Although the components of the present invention have been described in terms of specific components, it is contemplated that one or more of the components may be implemented in software on a general purpose computer, such as a laptop or desktop computer or a personal digital assistant (PDA) with a wireless (e.g., 802.11a, b, or g or blue tooth compliant) or wired (e.g., firewire compliant) interface. In this embodiment, one or more of the functions of the various components may be implemented in software that controls the general purpose computer. For example, the software may implement all functionality of the remote master control device when run on a PDA). This software may be embodied in a computer readable carrier, for example, a magnetic or optical disk, a memory-card or an audio frequency, radio-frequency or optical carrier wave.

In addition, although the invention is illustrated and described herein with reference to specific embodiments, the invention is not intended to be limited to the details shown. Rather, various modifications may be made in the details within the scope and range of equivalents of the claims and without departing from the invention.

1. An audio/video apparatus comprising:
a remote master control device configured to generate at least one master instruction;
a secondary control device configured to generate at least one secondary instruction; and
a signal processing device responsive to the at least one master instruction and selectively responsive to the at least one secondary instruction, wherein when the signal processing device receives one of the at least one master instruction, the signal processing device is non-responsive to a conflicting one of the at least one secondary instruction until the signal processing device receives an override instruction corresponding to the received master instruction.

2. The apparatus of claim 1, wherein the remote master control device is further configured to generate the at least one override instruction.

3. The apparatus of claim 1, wherein the remote master control device comprises at least a RF interface; the secondary control device comprises at least an IR interface, and the signal processing device comprises at least a RF interface and an IR interface for communicating with the RF interface and the IR interface of the remote master control device and the secondary control device, respectively.

4. The apparatus of claim 1, wherein the at least one master instruction is an OFF instruction, the at least one secondary instruction is a secondary ON instruction, and the at least one override instruction is a master ON instruction.

5. The apparatus of claim 1, wherein the signal processing device is further configured to receive an input signal having an audio component for aural presentation at a presentation device, wherein the at least one master instruction is a master audio mute instruction, and wherein the signal processing device inhibits the aural presentation of the audio component in response to the master audio mute instruction.

6. The apparatus of claim 1, wherein the signal processing device is further configured to receive an input signal having a video component for visual presentation at a presentation device, wherein the at least one master instruction is a master video mute instruction, and wherein the signal processing device inhibits the visual presentation of the video component in response to the master video mute instruction.

7. The apparatus of claim 1, wherein the remote master control device comprises a remote interface for transmitting the at least one master instruction and the at least one override instruction, wherein the remote master control device is capable of being locked and unlocked, and wherein, when locked, the remote master control device is incapable of transmitting at least one of the at least one master instruction and the at least one override instruction.

8. The apparatus of claim 1, wherein the remote master control device is capable of being locked and unlocked and wherein, when locked, the signal processing device does not acknowledge at least one of the at least one master instruction and the at least one override instruction.

9. The apparatus of claim 1, wherein the signal processing device presents a message at a presentation device responsive to one of the at least one master instruction generated by the remote master control device.

10. The apparatus of claim 9, wherein the message is an audio message, the remote master control device comprises a microphone for receiving the audio message from a user, and the remote master control device communicates the audio message to the signal processing device for aural presentation at the presentation device.

11. The apparatus of claim 9, wherein the message is a video message, the remote master control device comprises a user input for receiving the video message from a user, and the remote master control device communicates the video message to the signal processing device for visual presentation at the presentation device.

12. The apparatus of claim 1, wherein the signal processing device receives an audio component, the remote master control device comprises a speaker and is configured for bi-directional communication with the signal processing device, and the remote master control device is capable of receiving the audio component from the signal processing device and aurally presenting the audio component at the speaker.

13. The apparatus of claim 1, wherein the remote master control device includes a display and is configured for bi-directional communication with the signal processing device, the signal processing device receives a video component and is capable of passing the video component to the remote master control device, and the remote master control device is capable of receiving the video component from the signal processing device and visually presenting the video component on the display.

14. The apparatus of claim 13, wherein the signal processing device down samples the video component prior to passing the video component to the remote master control device and the remote master control device visually presents the down sampled video component on the display.

15. An audio/video apparatus comprising:
a remote control device configured to generate a rating selection signal; and
a signal processing device responsive to the rating selection signal, wherein the signal processing device is configurable in at least two rating selection modes and wherein the signal processing device is sequentially configured in one of the at least two rating selection modes responsive to the receipt of the rating selection signal from the remote control device.

16. The apparatus of claim 15, wherein the remote control device includes a plurality of keys and wherein the rating selection signal is generated in response to the depression of a single one of the plurality of keys.

17. An audio/video apparatus comprising:
a remote control device configured to generate a channel lock signal; and
a signal processing device responsive to the channel lock signal, wherein the signal processing device locks out the currently tuned channel upon receipt of the channel lock signal from the remote control device.

18. The apparatus of claim 17, wherein the signal processing device locks out the currently tuned channel for a predefined period of time responsive to the channel lock signal.

19. The apparatus of claim 17, wherein the signal processing device locks out the currently tuned channel for a remaining time period corresponding to a program being shown on the currently tuned channel responsive to the channel lock signal.

20. A remote control for use with a signal processing device comprising:
a transmitter capable of communication with the signal processing device; and
a controller coupled to the transmitter, wherein the controller is capable of generating and transmitting from the transmitter at least one control instruction capable of configuring the signal processing device, wherein the remote control device can be locked and unlocked, and wherein the signal processing device is not configured by at least one of the at least one control instruction when the remote control device is locked.

21. The remote control of claim 20, further comprising:
user inputs coupled to the controller, wherein the remote control device is locked and unlocked responsive to a password entered using the user inputs.

22. The remote control of claim 20, further comprising:
user inputs coupled to the controller, wherein the remote control device is locked responsive to a single keystroke of one of the user input and unlocked responsive to a password entered using the user inputs.

23. The apparatus of claim 20, wherein when the remote control device is locked, the remote control device does not transmit the at least one of the at least one control instruction.

24. The apparatus of claim 20, wherein when the remote control device is locked, the signal processing device does not acknowledge the at least one of the at least one control instruction.

25. An audio/video apparatus comprising:
a remote control device configured to generate at least one message instruction corresponding to a user defined message; and
a signal processing device configured to present the user defined message at a presentation device responsive to the at least one message instruction.

26. The apparatus of claim 25, wherein the user defined message is an audio message, the remote control device comprises a microphone for receiving the audio message from a user, and the remote control device communicates the audio message to the signal processing device for aural presentation at the presentation device.

27. The apparatus of claim 25, wherein the user defined message is a video message, the remote control device comprises a user input for receiving the video message from a user, and the remote control device communicates the video message to the signal processing device for visual presentation at the presentation device.

28. An audio/video apparatus comprising:
a remote control device configured to generate at least one monitoring instruction, wherein the remote control device includes at least one presentation component; and
a signal processing device configured for bi-directional communication with the remote control device, the signal processing device receiving an input signal and passing at least a portion of the input signal to the remote control device responsive to the at least one monitoring instruction for presentation by the at least one presentation component.

29. The apparatus of claim 28, wherein the input signal includes an audio component that is passed to the remote control device responsive to the at least one monitoring instruction and wherein the at least one presentation component is a speaker for aurally presenting the audio component.

30. The apparatus of claim 28, wherein the input signal includes a video component that is passed to the remote control device responsive to the at least one monitoring instruction and wherein the at least one presentation component is a display for visually presenting the video component.

31. The apparatus of claim 30, wherein the signal processing device down samples the video component prior to passing the video component to the remote control device and the remote control device visually presents the down sampled video component on the display.

32. A method for configuring a signal processing device comprising the steps of:
receiving at least one master instruction from a remote master control device;
receiving at least one secondary instruction from a secondary control device;
configuring a signal processing device responsive to the at least one master instruction; and
selectively configuring the signal processing device responsive to the at least one secondary signal, wherein, when one of the at least one master instruction is received, the signal processing device is not configured in response to a conflicting one of the at least one secondary instruction until an override instruction corresponding to the received master instruction is received.

33. The method of claim 32, wherein the at least one master instruction is an OFF instruction, the at least one secondary instruction is a secondary ON instruction, and the at least one override instruction is a master ON instruction.

34. The method of claim 32, further comprising:
receiving an input signal having an audio component for aural presentation at a presentation device, wherein the at least one master instruction is a master audio mute instruction, and wherein the aural presentation of the audio component is inhibited in response to the master audio mute instruction.

35. The method of claim 32, further comprising:
receiving an input signal having a video component for visual presentation at a presentation device, wherein the at least one master instruction is a master video mute instruction, and wherein the video presentation of the video component is inhibited in response to the master video mute instruction.

36. The method of claim 32, further comprising the step of
presenting a message at a presentation device responsive to one of the at least one master instructions generated by the remote master control device.

37. A rating selection method comprising the steps of:
receiving a rating selection signal from a remote control device; and
configuring a signal processing device responsive to the rating selection signal, wherein the signal processing device is sequentially configured in one of at least two rating selection modes responsive to the receipt of the rating selection signal from the remote control device.

38. The method of claim 37, wherein the rating selection signal is generated at the remote control device responsive to a single key press.

39. A channel lock out method comprising the steps of:
receiving a channel lock signal from a remote control device; and
configuring a signal processing device responsive to the channel lock signal, wherein the signal processing device is configured to lock out a currently tuned channel for a predefined period of time responsive to the receipt of the channel lock signal from the remote control device.

40. A channel lock out method comprising the steps of:
receiving a channel lock signal from a remote control device; and
configuring a signal processing device responsive to the channel lock signal, wherein the signal processing device is configured to lock out a currently tuned channel for a remaining time period corresponding to a program being shown on the currently tuned channel responsive to the receipt of the channel lock signal from the remote control device.

41. A method for locking a remote control comprising the steps of:
receiving a lock keystroke sequence at a remote control device configured for use with a signal processing device, the signal processing device selectively configured responsive to at least one control instruction capable of being generated and transmitted to the signal processing device by the remote control device, the remote control device capable of being locked and unlocked, wherein the signal processing device is configured responsive to the at least one control instruction when the remote control device is locked and the signal processing device is not configured responsive to the at least one control instruction when the remote control device is unlocked; and
locking the remote control device responsive to the lock keystroke sequence such that the signal processing device is not configured responsive to the at least one control instruction.

42. The method of claim 41, further comprising the steps of:
receiving an unlock keystroke sequence at the remote control device; and
unlocking the remote control device responsive to the unlock keystroke sequence such that the signal processing device is configured responsive to the at least one control instruction.

43. The method of claim 41, wherein when the remote control device is locked, the signal processing device does not acknowledge the at least one control instruction.

44. The method of claim 41, wherein when the remote control device is locked, the remote control device does not transmit the at least one control instruction.

45. A method for presenting a message on a presentation device comprising the steps of:
generating a message instruction at a remote control device;
receiving the message instruction at a signal processing device; and
presenting a message at a presentation device responsive to the message instruction generated by the remote control device.

46. The method of claim 45, wherein the message is a user defined message.

47. The method of claim 45, wherein the message is an audio message, the remote control device comprises a microphone for receiving the audio message from a user, and the remote control device communicates the audio message to the signal processing device for aural presentation at the presentation device.

48. The method of claim 45, wherein the message is a video message, the remote master control device comprises a user input for receiving the video message from a user, and the remote master control device communicates the video message to the signal processing device for visual presentation at the presentation device.

49. A method for monitoring programming presented on a presentation device, the method comprising the steps of:
receiving a monitoring instruction from a remote control device having at least one presentation component at a signal processing device, the signal processing device being configured to present an input signal at a presentation device;
passing at least a portion of the input signal to the remote control device responsive the received monitoring instruction; and
presenting the portion of the input signal at the at least one presentation component of the remote control device.

50. The method of claim 49, wherein the portion is an audio component of the input signal and the at least one presentation component is a speaker and wherein the audio component is aurally presented by the speaker at the remote control device.

51. The method of claim 49, wherein the portion is a video component of the input signal and the at least one presentation component is a display and wherein the video component is visually presented by the display at the remote control device.

52. The method of claim 51, wherein the signal processing device down samples the video component prior to passing the video component to the remote control device and the remote control device visually presents the down sampled video component on the display.

53. A system for configuring a signal processing device comprising:
means for receiving at least one master instruction from a remote master control device;
means for receiving at least one secondary instruction from a secondary control device;
means for configuring a signal processing device responsive to the at least one master instruction; and
means for selectively configuring the signal processing device responsive to the at least one secondary signal, wherein, when one of the at least one master instruction is received, the signal processing device is not configured in response to the receipt of a conflicting one of the at least one secondary instruction until an override instruction corresponding to the received master instruction is received.

54. A computer readable medium including software that is configured to control a general purpose computer to implement a method for configuring a signal processing device, the method comprising the steps of:
receiving at least one master instruction from a remote master control device;
receiving at least one secondary instruction from a secondary control device, one of the at least one secondary instruction in conflict with one of the at least one master instruction;
configuring a signal processing device responsive to the at least one master instruction; and
selectively configuring the signal processing device responsive to the at least one secondary signal, wherein, when one of the at least one master instruction is received, the signal processing device is not configured in response to a conflicting one of the at least one secondary instruction until an override instruction corresponding to the received master instruction is received.
